(19) United States
(12) Patent Application Publication
(10) Pub. No.: US 2016/0116436 A1
(43) Pub. Date: Apr. 28, 2016

(54) FREE-FLOW ELECTROPHORESIS DEVICE AND METHOD

(71) Applicants: Fletcher John AGOSTINO, Toronto (CA); Sergey KRYLOV, Toronto (CA)

(72) Inventors: Fletcher John AGOSTINO, Toronto (CA); Sergey N. KRYLOV, Toronto (CA)

(21) Appl. No.: 14/894,884

(22) PCT Filed: May 30, 2014
(86) PCT No.: PCT/CA2014/000468

§ 371 Date: Nov. 30, 2015

Related U.S. Application Data
(60) Provisional application No. 61/829,841, filed on May 31, 2013.

(51) Int. Cl. G01N 27/447; B01D 17/06; B01D 19/00; B01L 3/00

(52) U.S. Cl. CPC G01N 27/44769; B01L 3/502715; B01D 17/06; B01D 19/0068; B01L 3/502723; B01L 2400/0421; B01L 2300/089; B01L 2200/0684

(57) ABSTRACT

There is provided an electrophoresis device. The device includes a chamber, for containing liquid medium, the liquid medium including a flowing separation medium, carrying a sample, a pair of opposing electrodes for generating an electric field, with effect that the generated electric field effects spatial separation of the sample into sample fractions and, with respect to at least one of the electrodes, also effects generation of gaseous material from the liquid medium disposed at, or substantially at, an operative electrode surface of the electrode, with effect that the generated gaseous material becomes, at least initially, disposed within the liquid medium, wherein the generated gaseous material includes at least one generated gaseous compound, and at least one outlet for collecting a sample fraction. In some embodiments, for example, the device further includes a gas separator for inducing removal of at least a fraction of the generated gaseous material from the chamber, the gas separator including a space configured for effecting fluid communication between the liquid medium and a generated gaseous material receiving fluid phase such that a fluid interface is defined between the liquid medium and the generated gaseous material receiving fluid phase, and such that at least a fraction of the generated gaseous material migrates upwardly from its disposition at, or substantially at, the operative electrode surface to the fluid interface in response to buoyancy forces, and then from the fluid interface and into the generated gaseous material receiving fluid phase in response to a driving force. In some embodiments, the device further includes flow guides, disposed between the electrodes, for directing the flowing separation medium towards the at least one outlet. In some implementations, the flow guides mitigate the creation of a pH gradient.

### RELATED APPLICATIONS

This application claims the benefits of priority to U.S. Provisional Patent Application Ser. No. 61/829,841 filed on May 31, 2013.

### FIELD

The subject matter relates to electrophoresis, devices for effecting electrophoresis, and electrophoresis methods.

### BACKGROUND

Free-flow electrophoresis (“FFE”) is used for enabling fractionation of a sample into constituent components so as to enable analysis of the sample for its composition. Unfortunately, small-scale free-flow electrophoresis cannot be used for steady-state purification [A. Persat, M. E. Suss, J. G. Santiago, Lab Chip 2009, 9, 2454-2469]. Electrolysis of water leads to the formation of both gas bubbles (O₂ and H₂) and ions (H⁺ and OH⁻) at the electrodes.

Bubble accumulation on the electrodes and subsequently in other parts of the device leads to progressing electric field distortion and diminishing quality of purification within the first several minutes of operation [T. Revermann, S. Gotz, J. Kunnemeyer, U. Karst, Analyst 2008, 133, 167-174] [H. Vogt, J. App. Electrochem. 1983, 13, 87-88]. The regeneration of an FFE device requires complete bubble flush-out: a cumbersome and time-consuming process. The goal of this work was to find an ultimate solution for the problem of FFE instability caused by bubble accumulation, thereby permitting reliable steady-state operation without the distortion of electric field or separation quality. Solving the bubble-accumulation problem is pivotal to FFE integration with other micro-systems [R. Turgeon, M. T. Bowser, Anal. Bioanal. Chem. 2009, 394, 187-198].

The electrolytic ions, H+ and OH⁻, pose a problem because of their migration from the electrodes into the separation channel, where they can potentially alter the pH and conductivity of the electrolyte. Such pH gradients are undesirable when analyzing pH-sensitive species. pH gradients can affect the analytes by altering their structural conformation, reactivity, optical properties (which can render the analytes undetectable). In addition, the establishment of pH and conductivity gradients may diminish FFE separation quality by altering sample stream trajectories and causing band broadening.

### SUMMARY

In one aspect, there is provided an electrophoresis device comprising: a chamber for containing liquid medium, the liquid medium including a flowing separation medium, carrying a sample; a pair of opposing electrodes for generating an electric field, with effect that the generated electric field effects spatial separation of the sample into sample fractions and, with respect to at least one of the electrodes, also effects generation of gaseous material from the liquid medium disposed at, or substantially at, an operative electrode surface of the electrode, with effect that the generated gaseous material becomes, at least initially, disposed within the liquid medium, wherein the generated gaseous material includes at least one generated gaseous compound; at least one outlet for collecting a sample fraction; a gas separator for inducing removal of at least a fraction of the generated gaseous material from the chamber, the gas separator defining a space configured for effecting fluid communication between the liquid medium and a generated gaseous material receiving fluid phase such that a fluid interface is defined between the liquid medium and the generated gaseous material receiving fluid phase, and such that at least a fraction of the generated gaseous material migrates upwardly from its disposition at, or substantially at, the operative electrode surface to the fluid interface in response to buoyancy forces, and then from the fluid interface and into the generated gaseous material receiving fluid phase in response to a driving force.

In another aspect, there is provided an electrophoresis device including a chamber for containing liquid medium, the liquid medium including a flowing separation medium, carrying a sample; a pair of opposing electrodes for generating an electric field, with effect that the generated electric field effects spatial separation of the sample into sample fractions; at least one outlet for collecting a sample fraction; and flow guides, disposed between the electrodes, for directing the flowing separation medium towards the at least one outlet.

In a further aspect, there is provided a method for electrophoresis comprising: providing a chamber containing liquid medium, the liquid medium including flowing separation medium carrying a sample; effecting flow of the separation medium carrying an sample through the chamber; spatially separating the sample into sample fractions using an electric field generated by electrodes; generating gaseous material from the liquid medium that is in electrical communication with an operative electrode surface of at least one of the electrodes, in response to the generated electric field; collecting at least some of the sample fractions; and effecting removal of at least a fraction of the generated gaseous material by inducing upwardly migration of at least a fraction of the generated gaseous material to a fluid interface, in response to buoyancy forces, and across a fluid interface and into a generated gaseous material receiving fluid phase, in response to a driving force.

In yet a further aspect, there is provided a method for electrophoresis comprising: providing a chamber containing liquid medium, the liquid medium including flowing separation medium carrying a sample; effecting flow of the separation medium carrying an sample through the chamber; and spatially separating the sample into sample fractions using an electric field generated by electrodes; wherein the effecting flow of the flowing separation medium includes directing at least a fraction of the flow through flow guides, disposed between the electrodes, towards the at least one outlet.

### BRIEF DESCRIPTION OF DRAWINGS

The preferred embodiments will now be described with the following accompanying drawings, in which:

FIG. 1 shows a top perspective view of an embodiment of an electrophoresis device;

FIG. 2 shows a sectional elevation view, from a first end of the electrophoresis device in FIG. 1, taken along lines A-A;

FIG. 3 shows a sectional elevation view, from a first end of the electrophoresis device in FIG. 1, taken along lines B-B;

FIG. 4 shows a sectional elevation view, from a second end of the electrophoresis device in FIG. 1, taken along lines D-D;

FIG. 5 shows a sectional elevation view, from a second end of the electrophoresis device in FIG. 1, taken along lines E-E;

FIG. 6 is the same view as FIG. 3, and illustrates use of the electrophoresis device in fractionating a sample;

FIG. 7A shows a top plan view, in section, of the electrophoresis device in FIG. 3, taken along lines C1-C1, with the containment portion and electrodes shown in phantom;

FIG. 7B shows a top plan view, in section, of the electrophoresis device in FIG. 3, taken along lines C2-C2, with the containment portion and electrodes shown in phantom;

FIG. 8 shows a top perspective view of another embodiment of an electrophoresis device;

FIG. 9 shows a sectional elevation view, from a first end of the electrophoresis device in FIG. 9, taken along lines A1-A1;

FIG. 10 shows a sectional elevation view, from a first end of the electrophoresis device in FIG. 9, taken along lines B-B;

FIG. 11 shows a sectional elevation view, from a second end of the electrophoresis device in FIG. 9, taken along lines D-D;

FIG. 12 shows a sectional elevation view, from a second end of the electrophoresis device in FIG. 9, taken along lines E-E; and

FIG. 13 are schematic illustrations of the electrophoresis device used in the Example.

### DETAILED DESCRIPTION

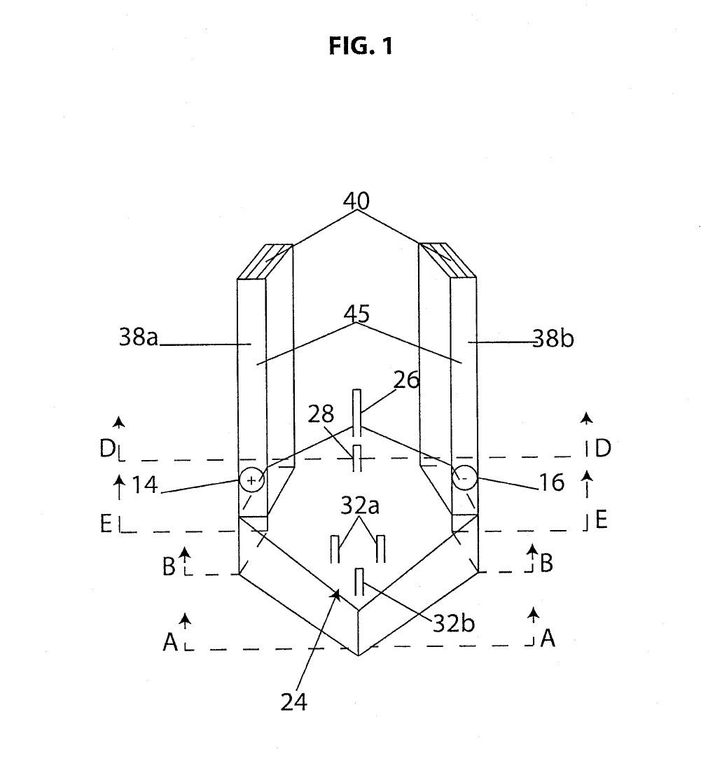

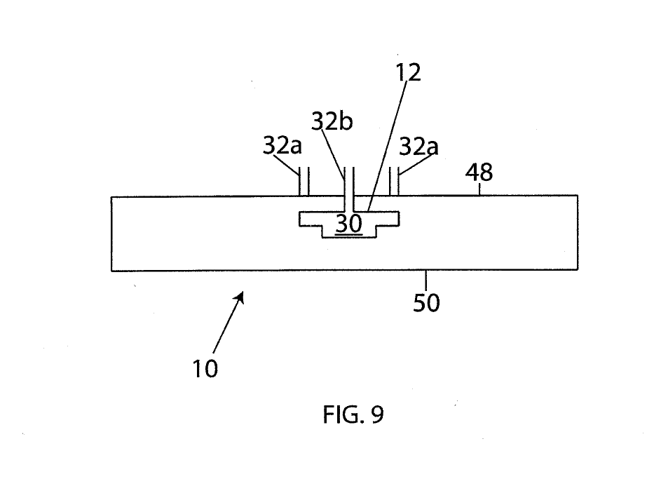

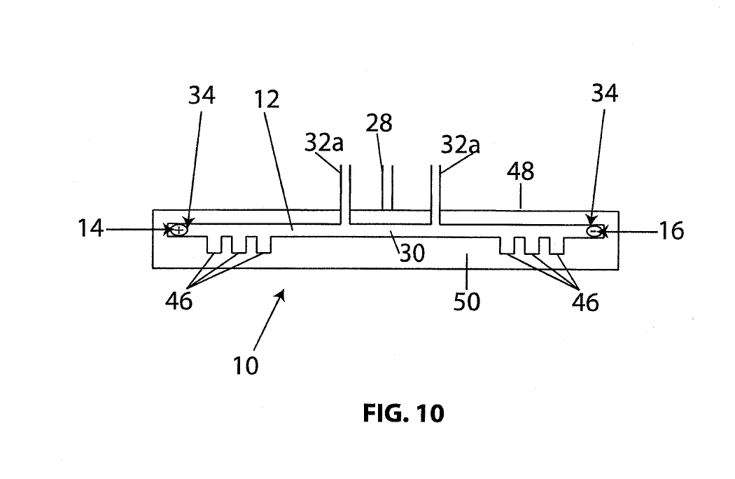

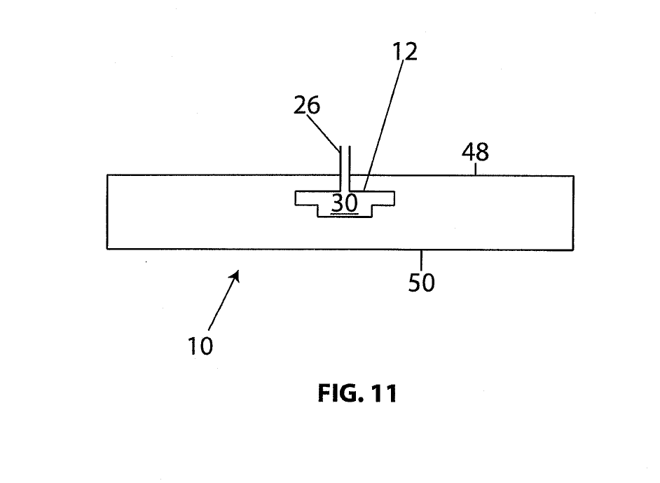

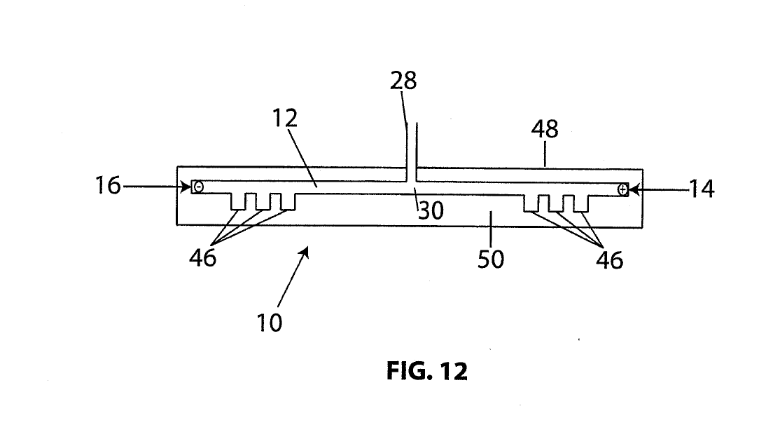

Referring to FIGS. 1 to 7, and FIGS. 8 to 12, there are provided embodiments of a free-flow electrophoresis device 10.

Free-flow electrophoresis is, for example, particularly suitable for effecting separation of reaction products resulting from continuous flow microsynthesis, and thereby enabling purification of such reaction products. It is also suitable, for example, for analyzing the composition of a sample.

The free-flow electrophoresis device 10 includes a chamber 12 and a pair opposing electrodes 14, 16. Each one of the electrodes 14, 16 can be made from any one of a number of compounds and compositions, and can be configured in any one of a number of geometries and sizes. An exemplary electrode material is platinum.

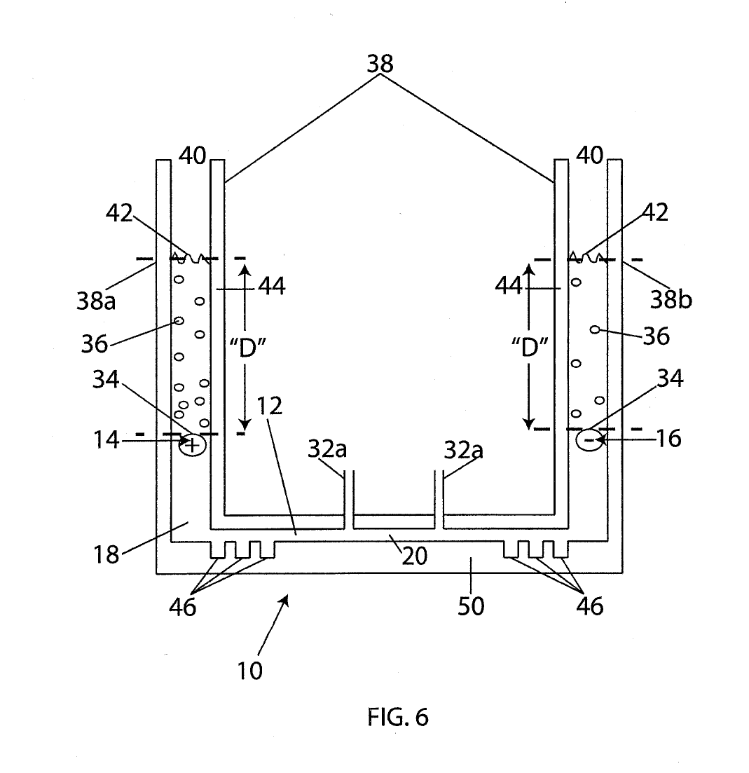

The chamber 12 is for containing liquid medium 18 (see FIG. 6). The liquid medium including a flowing separation medium 20 carrying a sample.

In some embodiments, for example, the flowing separation medium includes an electrolyte and a sample. The sample is being carried in the flowing separation medium.

Suitable examples of electrolyte include 4-(2-hydroxyethyl)-1-piperazine-ethanesulfonic acid (HEPES), phosphate buffer saline (PBS), and tris-acetate (TAE) as electrolytes.

Suitable sample candidates for free-flow electrophoresis include proteins, DNA, organelles, viruses, cells, bacteria, charged molecules (includes dyes), and enantiomers.

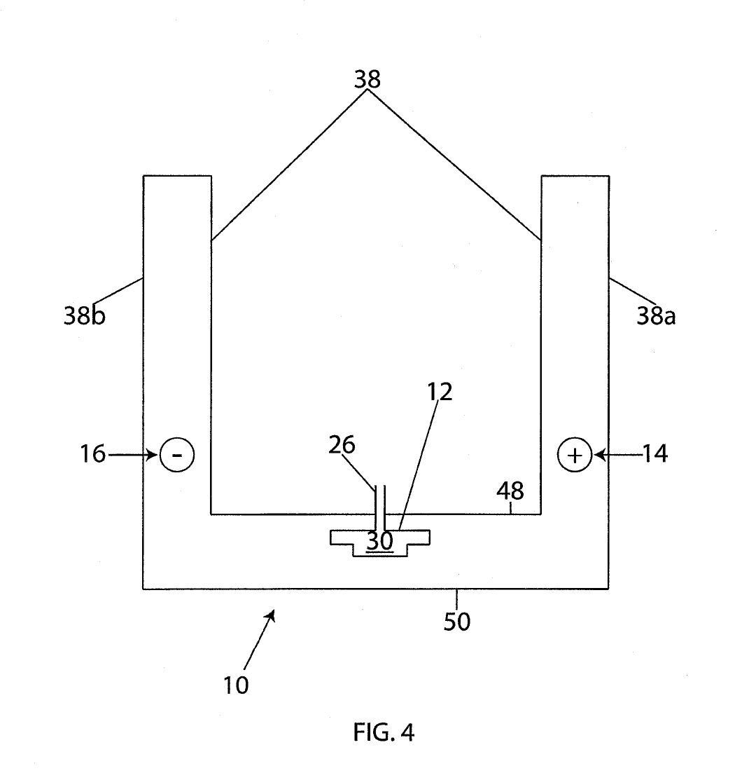

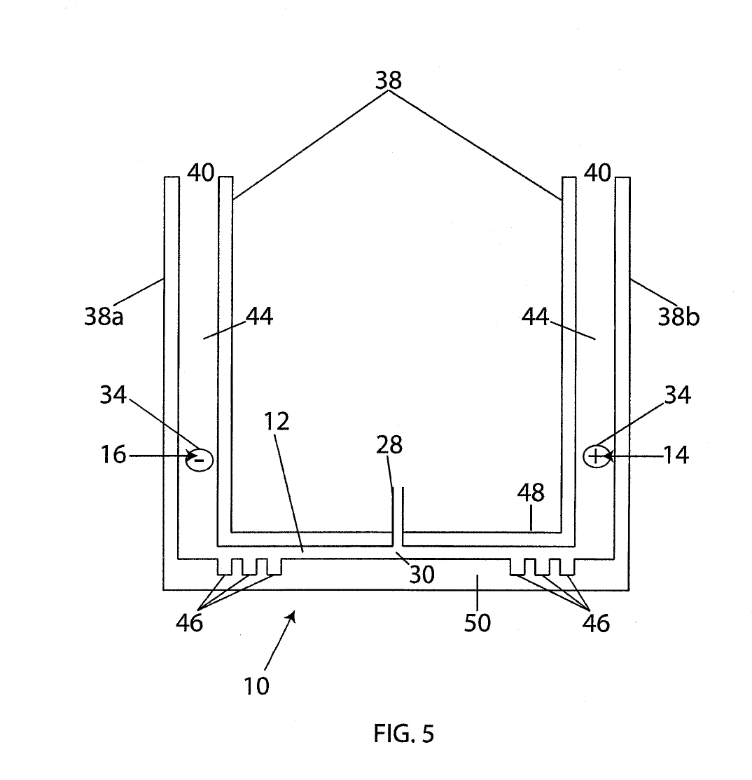

In some embodiments for example, the device 10 includes an inlet end 22 and an outlet end 24. Referring to FIGS. 4 and 5, the inlet end 22 includes one or more inlets 26 for introducing the flowing separation medium to the chamber. Further the inlet end 22 (one is shown) includes one or more inlets 28 (one is shown) for introducing the sample. In some embodiments, for example, the separation medium and the sample are co-introduced through the same inlet.

In some embodiments, for example, the flowing separation medium 20 carrying the sample is fluidically driven. In some of these embodiments, the flowing separation medium carrying the sample is fluidically driven by a pump, such as a dosing pump, which introduces the flowing separation medium into the chamber 12. Other suitable means for providing the necessary driving force for fluidically driving the flowing separation medium 20 include gas pressure and gravity.

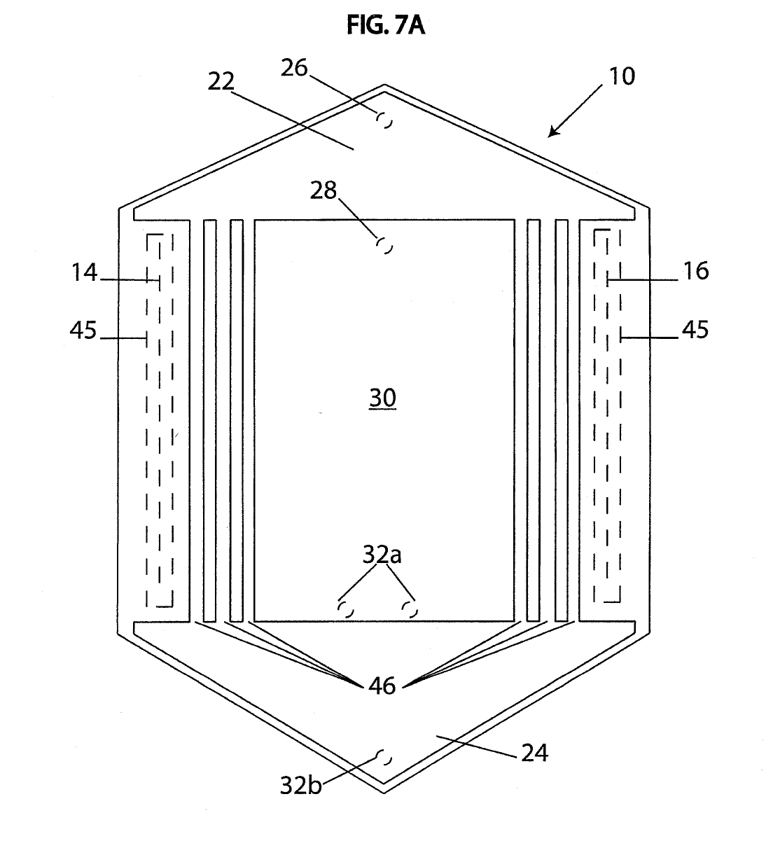

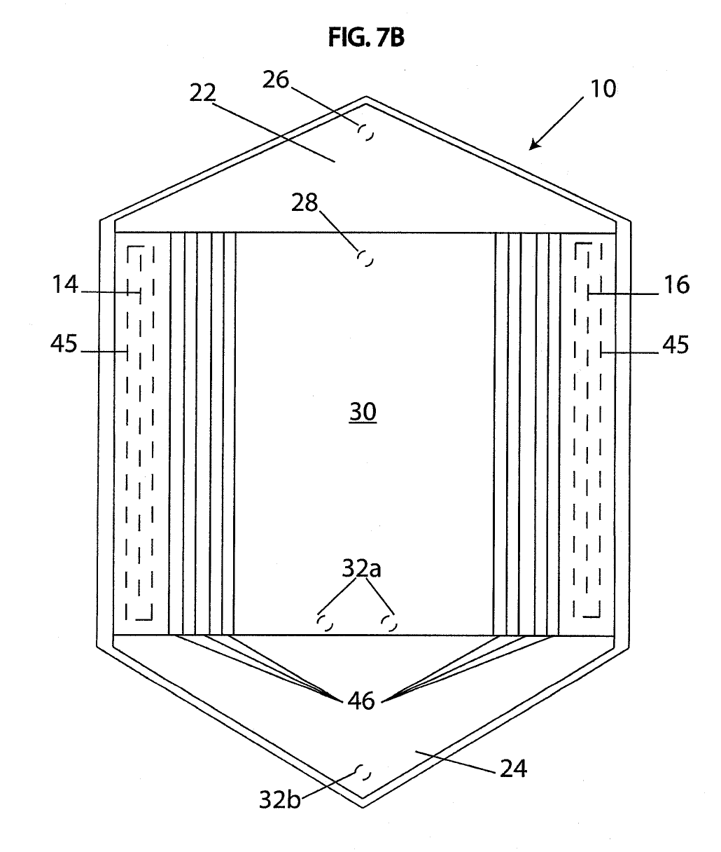

The pair of opposing electrodes are provided for generating an electric field. The electric field is generated by electrical coupling of the electrodes to a power source. Referring to FIGS. 7A and 7B, in some embodiments, for example, the electrodes 14, 16 extend lengthwise across the device 10.

In some embodiments, for example, the flowing separation medium 20 carrying the sample is flowed within the space 30 between the electrodes 14, 16. In some embodiments, for example, the direction of flow of the flowing separation medium carrying the sample is orthogonal to the streamlines of the electric field generated by the electrodes. In some embodiments, for example, the direction of flow of the flowing separation medium carrying the sample is other than orthogonal to the streamlines of the electric field generated by the electrodes.

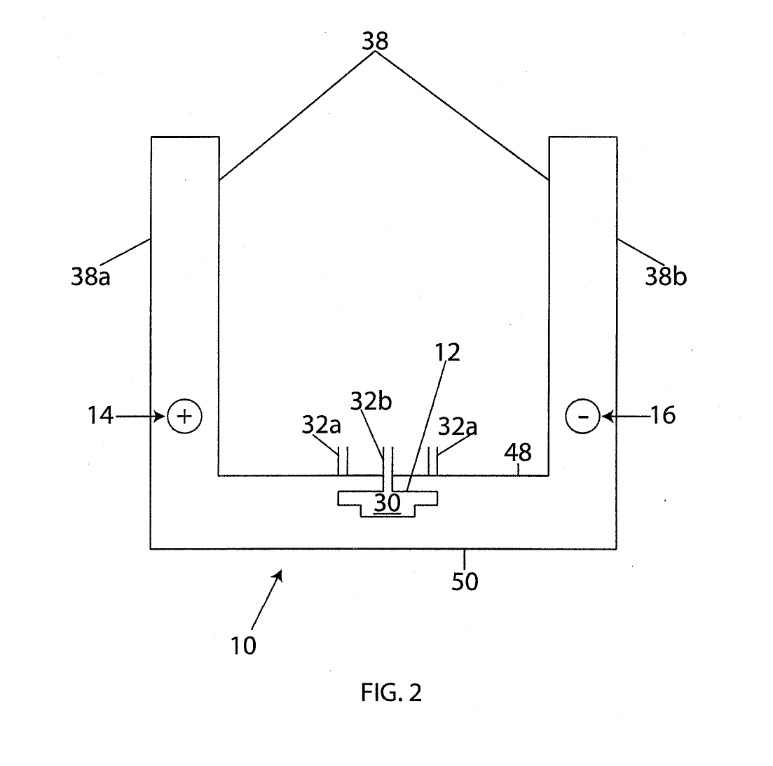

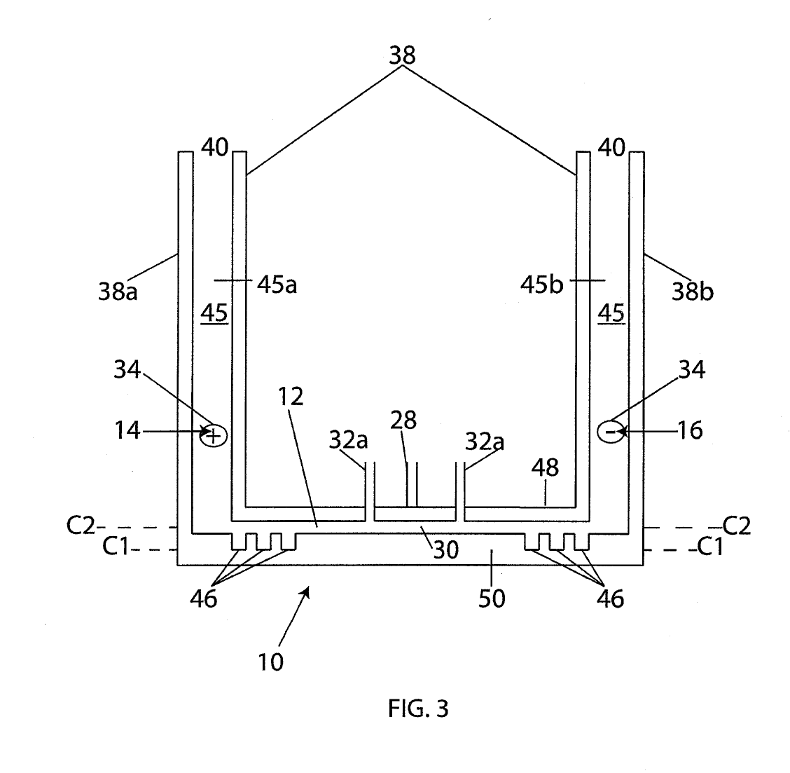

The generated electric field effects spatial separation of the sample into sample fractions. In this respect, in some embodiments, for example, the sample fractions manifest as multiple bands of unique compositions within the flowing separation medium, with material within a respective composition band being substantially uniform throughout the band. In some embodiments, for example, the sample is deflected laterally, relative to the flow of the flowing separation medium, into sample fractions. In some embodiments, for example, the spatial separation occurs downstream from where the sample is introduced. Referring to FIGS. 2 and 3, at least one outlet 32a (two are shown) is provided at the outlet end 24 of the device 10, for collecting one or more sample fractions. At least one outlet 32b (one is shown) is provided at the outlet end 24 of the device 10, for collecting the flowing separation medium 20.

In some embodiments, for example, it is preferable that the generated electric field uniformity is steady over time (for example, at least 12 hours) across the space 30 within which the flowing separation medium carrying the sample is flowing from the sample inlet 28 to the outlet 32.

The spatial separation of the sample into sample fractions, in response to the application of the generated electric field, is effected by virtue of differences in their respective electrophoretic mobilities, the electrophoretic mobility being a function of the size to charge ratio of a material component of the sample.

In some operational implementations, with respect to at least one of the electrodes 14, 16, the generated electric field also effects generation of gaseous material 36 from the liquid medium 16 disposed at, or substantially at, an operative electrode surface 34 of the electrode 14 or 16. The generated gaseous material includes at least one generated gaseous compound. The gaseous material is generated at, or substantially at, the operative electrode surface 34. The generated gaseous material becomes, at least initially, disposed within the liquid medium 18 at, or substantially at, the operative electrode surface 34.

In this respect, in one aspect, the device includes a gas separator 38 for inducing removal of at least a fraction of the generated gaseous material 36 from the chamber 12. The gas separator 38 includes or defines a space 45 configured for effecting fluid communication between the liquid medium 18 and a generated gaseous material receiving fluid phase 40 such that a fluid interface 42, disposed above the operative electrode surface 34 (at, or substantially at which the generated gaseous material is generated) is defined between the liquid medium 18 and the generated gaseous material receiving fluid phase 40. At least a fraction of the generated gaseous material migrates in an upwardly direction (not necessarily along a true vertical flowpath, but such an embodiment is not excluded) from its disposition at, or substantially at, the operative electrode surface to the fluid interface 42 in response to buoyancy forces, and then from the fluid interface 42 and into the generated gaseous material receiving fluid phase 40 in response to a driving force.

It is beneficial to effect removal of gaseous material 36 that is generated at, or substantially at, the electrodes. Otherwise, the gaseous material interferes with the generated electric field, resulting in the application of a non-uniform electric field, and thereby compromising the separation of the sample into desired fractions.

Referring to FIG. 6, in some embodiments, for example, the gaseous separator 38 is further configured with effect that, while the liquid medium 18 is disposed within the chamber 12, and while the fluid communication is being effected between the liquid medium 30 and the generated gaseous material receiving fluid phase 40, the fluid interface 42 is disposable within a space 45 defined within the gas separator 38 at a minimum distance “D” from the operative electrode surface that is as short as one (1) millimetre. In some embodiments, for example, the minimum distance “D” is as short as two (2) millimetres.

In some embodiments, for example, the electrode 14 or 16, having the operative electrode surface 34 whose electrical communication with the liquid medium 18, while the electric field is being generated, effects the generation of the gaseous material 36, is disposed in vertical alignment with the fluid interface 42.

In some embodiments, for example, the gas separator 38 includes a pair of gas separators 38a, 38b. Each one of the gas separators 38a, 38b independently, is disposed in association with a corresponding one of the electrodes 14 or 16 for inducing removal of at least a fraction of the gaseous material 36 that is generated from the liquid medium 18 that is disposed at, or substantially at, an operative electrode surface 34 of the corresponding electrode 14 or 16. Each one of the gas separators 38a, 38b independently, includes a space 45a, 45b configured for effecting fluid communication between the liquid medium 18 and a generated gaseous material receiving fluid phase 40 such that a fluid interface 42 is defined between the liquid medium 18 and the gaseous material receiving fluid phase 40, and such that a driving force is established for effecting migration of at least a fraction of the gaseous material 36 from the operative electrode surface 34, across the fluid interface 42, and into the generated gaseous material receiving fluid phase 40.

Where the gas separator 38 includes a pair of gas separators 38a, 38b, in some of these embodiments, for example, while the liquid medium 18 is disposed within the chamber 12, and while the fluid communication is being effected between the liquid medium 18 and the gaseous material receiving fluid phase 40, for each one of the gas separators 38a, 38b, independently, the fluid interface 42 is disposable within the space 45a (or 45b) of the respective gas separator 38a (or 38b), at a minimum distance “D” from the operative electrode surface that is as short as one (1) millimetre. In some embodiments, for example, the minimum distance “D” is as short as two (2) millimetres. the fluid interface 42 is disposable within the space 45a (or 45b) at a minimum distance “D” from the operative electrode surface that is as short as one (1) millimetre. In some embodiments, for example, the minimum distance “D” is as short as two (2) millimetres.

Also where the gas separator 38 includes a pair of gas separators 38a, 38b, in some of these embodiments, for example, for each one of the gas separators 38a, 38b, independently, the corresponding electrode 14 or 16, is disposed in vertical alignment with the fluid interface 42.

In some embodiments, for example, the driving force is established by providing that, for at least one generated gaseous compound of the generated gaseous material 36, the pressure of the generated gaseous compound, at the fluid interface 42, is greater than the partial pressure of the generated gaseous compound within the generated gaseous material receiving fluid phase 40.

In some embodiments, for example, the driving force is established by providing that the generated gaseous material receiving fluid phase 40 is a gaseous material, such as the atmosphere.

In some embodiments, for example, the space 45 (or, where the gas separator 38 includes separators 38a , 38b, then each one of the spaces 45a, 45b) is defined by a containment portion, and the space 45 (or, as the case may be, each one of the spaces 45a, 45b) is configured for receiving and containing an uppermost portion of the liquid medium 18 that, with the generated gaseous material receiving fluid phase 40, defines the fluid interface 42. The fluid interface 42 is disposed at a higher vertical elevation than the flowing separation medium 20 disposed between the electrodes 14, 16. The space is also configured for receiving of the generated gaseous material by the generated gaseous material receiving fluid phase 40 from the liquid medium.

In some embodiments, for example, the electrode 14 or 16, having the operative electrode surface 34 whose fluid contact with the liquid medium 18, while the electric field is being generated, effects the generation of the gaseous material 36, is disposed at a higher vertical elevation than the flowing separation medium 20 disposed between the electrodes 14, 16, and is also disposed below the fluid interface 42.

In some embodiments, for example, and referring to FIGS. 3, 5, 6, 7A, and 7B, the chamber 12 further includes flow guides 46, disposed between the electrodes, for directing the flowing separation medium 20 towards the at least one outlet 32. By directing the flowing separation medium 20 towards the at least one outlet 22, flow of the flowing separation medium 20 is less likely to divert towards the gas separator 38, thereby introducing errors into the quality of separation performance or mitigating the formation of pH gradients.

In some embodiments, for example, each one of the flow guides 46 is a flow-guiding channel. In some embodiments, for example, each one of the flow-guiding channels is divided from an adjacent flow-guiding channel by a channel divider, such that the channel dividers define the channels.

In some embodiments, for example, the chamber 12 is defined, at least in part, by upper and lower walls 48, 50, and wherein at least one of the upper and lower walls 48, 50 is shaped to define the flow guides 46.

In some embodiments, for example, the depth of the flow guides is at least 1.0 millimetres. In some of these embodiments, for example, the depth of the flow guides is at least 1.5 millimetres. In some of these embodiments, for example, the depth of the flow guides is at least 4.0 millimetres.

In some embodiments, for example, the total number of flow guides is two (2), with a single flow guide each positioned closer to a respective one of the gas separators, relative to the closest outlet 32. In some embodiments, for example, the total number of flow guides is four (4), with each one of two sets of two flow guides positioned closer to a respective one of the gas separators, relative to the closest outlet 32. In some embodiments, for example, the total number of flow guides is six (6), with each one of two sets of three flow guides positioned closer to a respective one of the gas separators, relative to the closest outlet 32. In some embodiments, for example, the total number of flow guides is eight (8), with each one of two sets of four flow guides positioned closer to a respective one of the gas separators, relative to the closest outlet 32.

In some embodiments, for example, the flow guides 46 define at least 10% of the total area of a cross-section of the chamber. In some of these embodiments, for example, the flow guides 46 define at least 20% of the total area of a cross-section of the chamber.

In some embodiments, for example, the flow guides 46 are disposed closer to one of the gas separators 38a, 38b relative to the closest outlet 32.

In some embodiments, for example, the device 10 includes any one of the embodiments of the flow guides 46, described above, but does not include the gas separator 38.

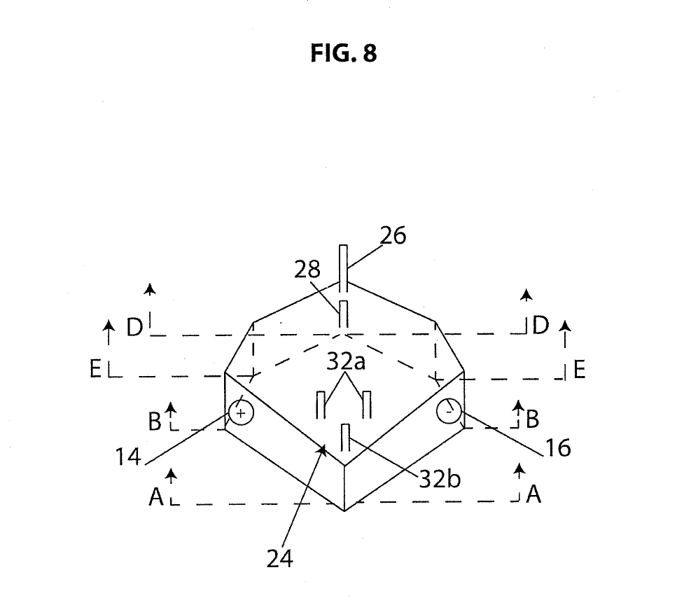

In this respect, in another aspect, and referring to FIGS. 8 to 12, the device includes a chamber 12 for containing liquid medium, the liquid medium including a flowing separation medium, carrying a sample, a pair of opposing electrodes 14, 16 for generating an electric field, with effect that the generated electric field effects spatial separation of the sample into sample fractions, at least one outlet (32a, 32b) for collecting a sample fraction, and flow guides 46, disposed between the electrodes 14, 16, for directing the flowing separation medium towards the at least one outlet 32.

There is further provided a method for electrophoresis, and the method includes effecting electrophoresis using any one of the embodiments of the electrophoresis device 10, as described above.

In one aspect, the method includes:

providing a chamber 12 containing liquid medium 18, the liquid medium including flowing separation medium 20 carrying an sample;

effecting flow of the separation medium 20 carrying an sample through the chamber;

spatially separating the sample into sample fractions using an electric field generated by electrodes 14, 16;

generating gaseous material 36 from the liquid medium 18 that is disposed at or substantially at, an operative electrode surface 34 of at least one of the electrodes 14, 16, in response to the generated electric field;

collecting at least some of the sample fractions; and

effecting upwardly migration (not necessarily along a true vertical flowpath, but such an embodiment is not excluded) of at least a fraction of the generated gaseous material 36 to a fluid interface 42, in response to buoyancy forces, and across a fluid interface 42 and into a generated gaseous material receiving fluid phase 40, in response to a driving force.

In some embodiments, for example, the migration from the operative electrode surface 34 to the fluid interface 42 is across a minimum distance “D” (see FIG. 6) that is less than twenty-five milimetres.

In some embodiments, for example, the method further includes:

providing a vertical flowpath, for migration of at least a fraction of the generated gaseous material 36 from the operative electrode surface 34, across a fluid interface 42, and into a generated gaseous material receiving fluid phase 40; and

effecting migration of at least a fraction of the generated gaseous material 36 to a fluid interface 42 along the vertical flowpath, in response to buoyancy forces, and then across the fluid interface 42 and into the generated gaseous material receiving fluid phase 40, in response to a driving force.

In some embodiments, for example, the method further comprises establishing the driving force.

In some embodiments, for example, the establishing of the driving force includes establishing, for at least one generated gaseous compound of the generated gaseous material 36, a pressure of the generated gaseous compound, at the fluid interface 42, that is greater than the partial pressure of the generated gaseous compound within the generated gaseous material receiving fluid phase 40.

In some embodiments, for example, the establishing the driving force incudes providing a generated gaseous material receiving fluid phase 40 that is a gaseous material, such as the atmosphere.

In some embodiments, for example, the method further comprises containing the fluid interface 42 at a higher vertical elevation than the flowing separation medium 20 disposed between the electrodes 14, 16.

In some embodiments, for example, the method further comprises providing the electrode 14 or 16 having the operative electrode surface 34, whose fluid contact with the liquid medium 36, while the electric field is being generated, effects the generation of the gaseous material 18, at a higher vertical elevation than that of the flowing separation medium disposed between the electrodes, and also below the fluid interface.

In some embodiments, for example, the effecting flow of the flowing separation medium 20 includes directing at least a fraction of the flow through flow guides 46, disposed between the electrodes 14, 16, towards the at least one outlet 32.

In some embodiments, for example, at least 10% of the total volume of the flowing separation medium 20 within the chamber is directed through the flow guides 46. In some of these embodiments, for example, at least 20% of the total volume of the flowing separation medium 20 within the chamber is directed through the flow guides 46.

In another aspect, the method includes:

providing a chamber containing liquid medium, the liquid medium including flowing separation medium carrying a sample;

effecting flow of the separation medium carrying an sample through the chamber; and

spatially separating the sample into sample fractions using an electric field generated by electrodes;

wherein the effecting flow of the flowing separation medium includes directing at least a fraction of the flow through flow guides, disposed between the electrodes, towards the at least one outlet.

In some embodiments, for example, at least 10% of the total volume of the flowing separation medium within the chamber is directed through the flow guides.

Further embodiments will now be described in further detail with reference to the following non-limitative examples.

### EXAMPLE NO. 1

All reagents were purchased from Sigma Aldrich, unless otherwise mentioned. FFE prototypes were fabricated using a MDX-540 robotic milling machine (Roland DGA, Irvine, Calif.). The stock material used was poly(methyl methacrylate) (PMMA) (Johnston Industrial Plastics, Toronto, Canada), and was cut using a series of end mill tools to accurately and precisely shape the prototypes. The optimized cutting speeds for the end mills have already been described in full detail (Agostino, F. J.; Evenhuis, C. J.; Krylov, S. N. J. Sep. Sci. 2011, 34, 556-564).

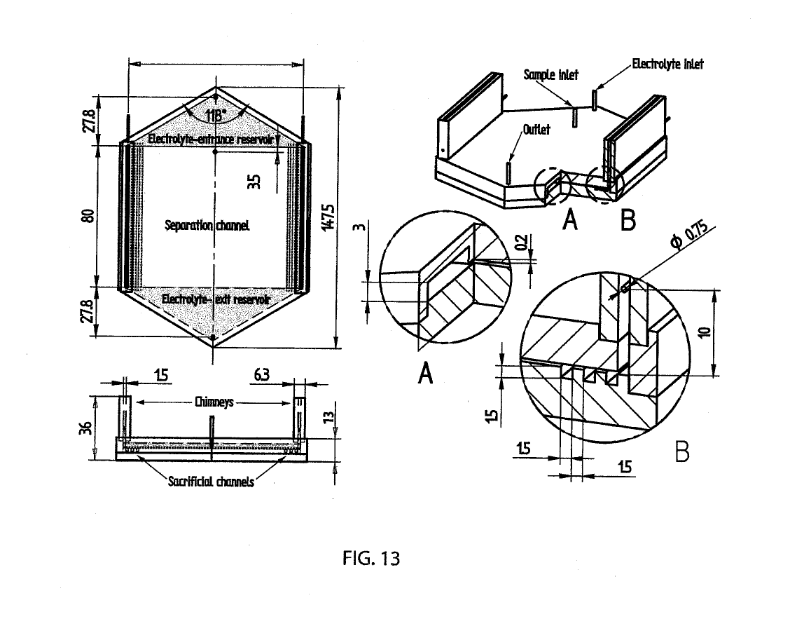

Fabrication of FFE involves milling bottom, top, and chimney substrates. The three substrates are then bonded together using small volumes of dichloromethane (CH₂Cl₂). CH₂Cl₂ was injected carefully to provide a tight seal at the edges of the device. The device was clamped together for 10 minutes to allow the solvent to completely perfuse and dry at the edges. Platinum electrodes (100 mm long and 0.75 mm in diameter) were installed into the chimneys and connected with insulated copper wires to a power source. The power source used was a high-voltage Electrophoresis Power Supply EPS 3501 XL (Amersham Pharmacia Biotech, New Jersey, USA). The completed device, with the appropriate dimensions, can be found in FIG. 13.

Metal Luer Stubs (of internal diameters depicted in FIG. 13) were used as fluidic adapters and polyethylene tubing was used to transfer the electrolyte and sample to the FFE device. Loctite® 409 (Henkel, Mississauga, Canada) was used to seal the adapters to the device and allowed to cure for 1 h. Any openings, holes, or extra spaces were filled with Loctite® to prevent leaks. A Nikon 7000 digital camera was mounted on a tripod and was used to record images.

The electrolyte was prepared with 25 mM 4-(2-hydroxyethyl)-1-piperazineethanesulfonic acid (HEPES) (99.5%) and was adjusted with 10 M NaOH to pH 7.5. Triton X-100 (0.001 [w/v]) was added, and the mixture was deoxygenated by bubbling with N₂ overnight. The electrolyte was then used to prepare a sample solution of 250 mM fluorescein, rhodamine B, and rhodamine 6G each. All solutions were prepared using de-ionized H₂O.

The hydrodynamic flow of the electrolyte was driven by a continuous flow syringe pump system (New Era Pump System Inc, Farmingdale, N.Y., USA). The electrolyte flow rates in the experiment highlighted in the paper was 5.00±0.05 mL/min. A separate syringe pump (Harvard Apparatus Pump II, Saint-Laurent, Canada) was used to introduce the sample at a flow rate of 4.00±0.01 μL/min. Experiments were carried out at room temperature (22° C.). The FFE device was placed on top of metal blocks, which were in contact with ice packs, to help prevent overheating.

Before using the device, it was placed into the oven over night at 65° C. This was to ensure that the plastic was not wet. The wet surface caused the device to swell and clog the channels. The FFE device was allowed to cool to room temperature after removal from the oven. A 10% EtOH solution was passed through the device to wet the entire surface prior to the electrolyte. The electrolyte was then introduced along with the sample at the prescribed flow rates mentioned above. The voltage applied to the system was 500 V, which represents an electric field strength of 50.0 V/cm inside the separation channel. For 12 hours, the current was recorded and digital pictures were taken to monitor the sample separation quality in the presence of an electric field. Bubbles were successfully detached from the surface of the electrodes, but we added an occasional mechanical shock to the chimneys to aid in detachment. After the device was used, it was flushed with de-ionized H₂O to wash out any remaining electrolyte and placed back in the oven to dry overnight at 65° C.

The device was first tested for flow uniformity. The sample flow had relatively straight streamlines suggesting that the optimization was successful, and once again proving the accuracy of the virtual device operation. We then tested the device for bubble formation. Bubbles formed on the electrodes and dislodged from them when they reached the critical size. Bubbles vented out into the atmosphere and did not enter the separation channel. Under such conditions the electric current showed no drift during a 12-h period of continuous work, thus, suggesting its steady-state bubble removal.

The device was also tested for stability of electrophoretic separation. A mixture of three dyes (rhodamine B, rhodamine 6G, and fluorescein) was continuously injected by a syringe pump that provided uninterrupted injection for 12 h. The stability of separation was judged by the steadiness of the 3 streamlines. No deterioration in separation quality was noticed, suggesting the steady-state operation of the device. On the other hand, only negligible widening of streamlines during their passage through the separation channel suggests minimal contribution from multiple sources of band-broadening such as diffusion, injection bandwidth, convection, and hydrodynamic broadening. Injection bandwidth is limited by simply decreasing the diameter of the sample inlet. Decreasing the depth of the separation channel reduces convective and hydrodynamic broadening. Therefore, not only can this device support steady-state continuous separation, but it also satisfies the general requirement of negligible band broadening.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

1. An electrophoresis device comprising:
a chamber, for containing liquid medium, the liquid medium including a flowing separation medium, carrying a sample;
a pair of opposing electrodes for generating an electric field, with effect that the generated electric field effects spatial separation of the sample into sample fractions and, with respect to at least one of the electrodes, also effects generation of gaseous material from the liquid medium disposed at, or substantially at, an operative electrode surface of the electrode, with effect that the generated gaseous material becomes, at least initially, disposed within the liquid medium, wherein the generated gaseous material includes at least one generated gaseous compound;
at least one outlet for collecting a sample fraction; and
a gas separator for inducing removal of at least a fraction of the generated gaseous material from the chamber, the gas separator including a space configured for effecting fluid communication between the liquid medium and a generated gaseous material receiving fluid phase such that a fluid interface is defined between the liquid medium and the generated gaseous material receiving fluid phase, and such that at least a fraction of the generated gaseous material migrates upwardly from its disposition at, or substantially at, the operative electrode surface to the fluid interface in response to buoyancy forces, and then from the fluid interface and into the generated gaseous material receiving fluid phase in response to a driving force.

2. The electrophoresis device as claimed in claim 1;
wherein the space of the gaseous separator is further configured with effect that, while the liquid medium is disposed within the chamber, and while the fluid communication is being effected between the liquid medium and the generated gaseous material receiving fluid phase, the fluid interface is disposable within the gas separator at a minimum distance from the operative electrode surface that is as short as one (1) millimetre.

3. The electrophoresis device as claimed in claim 1;
wherein the electrode, having the operative electrode surface whose electrical communication with liquid medium, while the electric field is being generated, effects the generation of the gaseous material, is disposed in vertical alignment with the fluid interface.

4. The electrophoresis device as claimed in claim 1;
wherein the driving force is that established by providing that, for at least one generated gaseous compound of the generated gaseous material, the pressure of the generated gaseous compound, at the fluid interface, is greater than the partial pressure of the generated gaseous compound within the generated gaseous material receiving fluid phase.

5. The electrophoresis device as claimed in claim 1;
wherein the driving force is that established by providing that the generated gaseous material receiving fluid phase is the atmosphere.

6. (canceled)

7. The electrophoresis device as claimed in claim 1;
wherein the gas separator further includes a containment portion that defines the space, and the space is further configured for receiving and containing a portion of the liquid medium, such that the fluid interface between the liquid medium and the generated gaseous material receiving fluid phase is disposed at a higher vertical elevation than the flowing separation medium disposed between the electrodes.

8. The electrophoresis device as claimed in claim 1;
wherein the electrode, having the operative electrode surface whose fluid contact with the liquid medium, while the electric field is being generated, effects the generation of the gaseous material, is disposed at a higher vertical elevation than the flowing separation medium disposed between the electrodes, and is also disposed below the fluid interface.

9. The electrophoresis device as claimed in claim 1;
wherein the electrode, having the operative electrode surface whose electrical communication with the liquid medium, while the electric field is being generated, effects the generation of the gaseous material, is disposed in vertical alignment with the fluid interface.

10. The electrophoresis device as claimed in claim 1;
wherein the chamber further includes flow guides, disposed between the electrodes, for directing the flowing separation medium towards the at least one outlet.

11. The electrophoresis device as claimed in claim 10;
wherein each one of the flow guides is a flow-guiding channel said flow guiding channels divided from one another by channel dividers, such that the channel dividers define the channels.

12. (canceled)

13. The electrophoresis device as claimed in claim 10;
wherein the chamber is defined, at least in part, by upper and lower walls, and wherein at least one of the upper and lower walls is shaped to define the flow guides.

14. The electrophoresis device as claimed in claim 10;
wherein the flow guides define at least 10% of the total area of a cross-section of the chamber.

15. The electrophoresis device as claimed in claim 10;
wherein the flow guides are disposed closer to the gas separator, relative to the closest outlet.

16. The electrophoresis device as claimed in claim 1;
wherein the gas separator includes a pair of gas separators, each one of the gas separators, independently, being disposed in association with a corresponding one of the electrodes for inducing removal of at least a fraction of the gaseous material that is generated from the liquid medium that is disposed at, or substantially at, an operative electrode surface of the corresponding electrode, and includes a separator space configured for effecting fluid communication between the liquid medium and a generated gaseous material receiving fluid phase such that a fluid interface is defined between the liquid medium and the gaseous material receiving fluid phase, and such that at least a fraction of the generated gaseous material migrates from its disposition at, or substantially at, the operative electrode surface to the fluid interface in response to buoyancy forces, and then from the fluid interface and into the generated gaseous material receiving fluid phase in response to a driving force.

17. (canceled)

18. A method for electrophoresis comprising:
providing a chamber containing liquid medium, the liquid medium including flowing separation medium carrying a sample;
effecting flow of the separation medium carrying an sample through the chamber;
spatially separating the sample into sample fractions using an electric field generated by electrodes;
generating gaseous material from the liquid medium that is in electrical communication with an operative electrode surface of at least one of the electrodes, in response to the generated electric field;
collecting at least some of the sample fractions; and
effecting removal of at least a fraction of the generated gaseous material by inducing upwardly migration of at least a fraction of the generated gaseous material to a fluid interface, in response to buoyancy forces, and across a fluid interface and into a generated gaseous material receiving fluid phase, in response to a driving force.

19. The method as claimed in claim 18;
wherein the migration from the operative electrode surface to the fluid interface is across a minimum distance of less than 25 millimetres.

20. The method as claimed in claim 18, further comprising:
providing a vertical flowpath, for migration of at least a fraction of the generated gaseous material from the operative electrode surface, across a fluid interface, and into a generated gaseous material receiving fluid phase; and
effecting migration of at least a fraction of the generated gaseous material to a fluid interface along the vertical flowpath, in response to buoyancy forces, and then across the fluid interface and into the generated gaseous material receiving fluid phase, in response to a driving force.

21. The method as claimed in claim 18;
establishing the driving force, wherein the establishing of the driving force includes establishing, for at least one generated gaseous compound of the generated gaseous material, a pressure of the generated gaseous compound, at the fluid interface, that is greater than the partial pressure of the generated gaseous compound within the generated gaseous material receiving fluid phase.

22. (canceled)

23. The method as claimed in claim 18, further comprising;
establishing the driving force by providing a generated gaseous material receiving fluid phase that is the atmosphere.

24. (canceled)

25. The method as claimed in claim 18, further comprising;
containing the fluid interface at a higher vertical elevation than the flowing separation medium disposed between the electrodes.

26. The method as claimed in claim 18, further comprising:
providing the electrode having the operative electrode surface whose fluid contact with the liquid medium, while the electric field is being generated, effects the generation of the gaseous material, at a higher vertical elevation than the flowing separation medium disposed between the electrodes, and also below the fluid interface.

27. The method as claimed in claim 18;
wherein the effecting flow of the flowing separation medium includes directing at least a fraction of the flow through flow guides, disposed between the electrodes, towards the at least one outlet.

28. The method as claimed in claim 27;
wherein at least 10% of the total volume of the flowing separation medium within the chamber is directed through the flow guides.

29. An electrophoresis device comprising:
a chamber for containing liquid medium, the liquid medium including a flowing separation medium, carrying a sample;
a pair of opposing electrodes for generating an electric field, with effect that the generated electric field effects spatial separation of the sample into sample fractions;
at least one outlet for collecting a sample fraction; and
flow guides, disposed between the electrodes, for directing the flowing separation medium towards the at least one outlet.

30. (canceled)

31. (canceled)

32. (canceled)

33. (canceled)

34. (canceled)

35. A method for electrophoresis comprising:
providing a chamber containing liquid medium, the liquid medium including flowing separation medium carrying a sample;
effecting flow of the separation medium carrying an sample through the chamber; and
spatially separating the sample into sample fractions using an electric field generated by electrodes;
wherein the effecting flow of the flowing separation medium includes directing at least a fraction of the flow through flow guides, disposed between the electrodes, towards the at least one outlet.

36. (canceled)
